(19) United States
(12) Patent Application Publication
(10) Pub. No.: US 2025/0381836 A1
(43) Pub. Date: Dec. 18, 2025

(54) MANIFOLD REFRIGERANT MODULE

(71) Applicant: Hanon Systems, Daejeon (KR)

(72) Inventor: Se Woong LEE, Daejeon (KR)

(73) Assignee: Hanon Systems, Daejeon (KR)

(21) Appl. No.: 19/074,180

(22) Filed: Mar. 7, 2025

(30) Foreign Application Priority Data
Jun. 12, 2024 (KR) 10-2024-0076132

(51) Int. Cl. B60K 11/02

(52) U.S. Cl. CPC B60K 11/02

(57) ABSTRACT

The present invention relates to a manifold refrigerant module, and more specifically, to a manifold refrigerant module which includes a manifold which is disposed at an upper side in a direction of gravity and in which a plurality of fluid flow paths are formed, and at least one heat exchanger coupled to a lower side of the manifold and configured to communicate with the flow path through an inlet and an outlet so that a fluid flows and is heat-exchanged, wherein the inlet is disposed above the outlet in the heat exchanger.

### CROSS REFERENCE TO RELATED APPLICATION

The present application claims priority to Korean Patent Application No. 10-2024-0076132, filed on Jun. 12, 2024, the entire contents of which is incorporated herein for all purposes by this reference.

### BACKGROUND OF THE INVENTION

### Field of the Invention

The present invention relates to a manifold refrigerant module, and more specifically, to a manifold refrigerant module having a structure for preventing oil and refrigerant from being trapped inside a refrigerant manifold and a heat exchanger in the refrigerant manifold connected to the heat exchanger.

### Description of the Related Art

Recently, as interest in environmental pollution issues has increased, research and development and production of eco-friendly vehicles are being actively conducted. In general, the eco-friendly vehicles include electric vehicles driven using fuel cells or electricity as a power source, and hybrid electric vehicles driven using an engine and batteries as a power source.

The electric vehicle or the hybrid electric vehicle includes power electronics (PE) parts including a motor, an inverter, and an onboard charger, and batteries for providing power to the PE parts. In this case, since the PE parts or the batteries generate heat during operation, cooling treatment is essential to protect the parts, ensure durability, and improve the performance of the motor. In addition, in electric vehicles in which heat energy is generated by a chemical reaction, effectively removing the generated heat is directly related to the performance of the fuel cell.

That is, the electric vehicles or the hybrid electric vehicles are provided with a cooling system for cooling the PE parts or the batteries. The cooling system may include a plurality of pipes so that built-in coolant circulates through each device which requires cooling and is heat-exchanged. In this case, the pipes can be formed in consideration of the type of vehicle, the types of devices installed in an engine room, the capacity of the cooling system, the types and number of coolants, and the like and can have a very complicated structure in which a number of pipes and devices are coupled.

To solve this, the cooling system of the vehicle can be modularized to provide ease of assembly and maintenance. Modularization can be done by coupling the devices of the cooling system to the manifold, and in this case, the manifold is a component which has optimized the arrangement of a plurality of pipes formed to allow a fluid to flow between heat exchangers or other devices in a cooling system and has been integrated.

Here, when modularizing refrigerant-related components of the cooling system, it can be formed as a refrigerant manifold. The refrigerant manifold module is formed by assembling heat exchangers such as a chiller, a condenser, and the like and a manifold in which flow paths connecting components including the heat exchangers are integrated. In this case, the manifold preferably has an inlet and an outlet, which are ends of each flow path, connected by forming a closed circuit with the heat exchangers. A configuration of the flow path of the refrigerant manifold can be variously designed differently depending on factors such as the type of vehicle, main components such as an engine and a motor, and the type and number of heat exchange media required.

In this case, depending on positions of the inlet and outlet of the heat exchanger, a pressure drop can occur inside the heat exchanger of the cooling system. For example, when the inlet and outlet of the heat exchanger are disposed continuously at an upper side of the heat exchanger, a pressure drop can occur in the heat exchanger due to gravity when refrigerant moves, and the pressure drop can cause oil and refrigerant to be trapped in the heat exchanger with a high probability. In addition, when oil and refrigerant are trapped, a normal fluid flow is blocked by the trap, resulting in problems that more energy is consumed to move the fluid, the heat transfer efficiency of the exchanger is reduced due to heat transfer obstruction, and the life is shortened due to corrosion and deterioration.

### SUMMARY OF THE INVENTION

The present invention has been made in efforts to solve the above problems and is directed to providing a refrigerant manifold module having a structure of preventing oil and refrigerant from being trapped in a heat exchanger and a refrigerant manifold and to providing a refrigerant manifold module in which a position of a connection port structure of a heat exchanger and a refrigerant manifold is restricted to increase heat efficiency by reducing possibility of trapping and smoothing a flow of refrigerant, and formation of a flow path and connection between the heat exchanger and the refrigerant manifold are simplified in consideration of the difficulty of installation, thereby reducing manufacturing cost and providing ease of installation in a vehicle.

A manifold refrigerant module of the present invention includes a manifold which is disposed at an upper side in a direction of gravity and in which a plurality of fluid flow paths are formed, and at least one heat exchanger coupled to a lower side of the manifold and configured to communicate with the flow path through an inlet and an outlet so that a fluid flows and is heat-exchanged, wherein the inlet is disposed above the outlet in the heat exchanger.

In this case, at least one of the inlet and the outlet of the heat exchanger is disposed at a lower end side of the heat exchanger.

In this case, the inlet and the outlet of the heat exchanger are disposed adjacent to each other in a direction of gravity by an assembly port.

Here, the at least one of the inlet and the outlet is positioned at a corner side of the heat exchanger.

In addition, the manifold includes a flow path part positioned at a lower side thereof and including a plurality of flow paths formed through vacuum brazing, and a valve block positioned above the flow path part and for installation of a valve configured to control a flow of a fluid flowing along the flow path.

In this case, the assembly port is positioned at a side farthest from the valve block.

In this case, the heat exchanger forms a fluid flow in which a fluid introduced through the inlet circulates clockwise or counterclockwise along a flat surface of the heat exchanger and then is discharged through the outlet.

In addition, the heat exchanger forms a fluid flow in which a fluid introduced through the inlet circulates along a flat surface of the heat exchanger, moves downward in the direction of gravity, and then is discharged through the outlet.

In this case, the heat exchanger can minimize a pressure drop by the fluid flow moving downward in the direction of gravity, thereby preventing refrigerant from being trapped.

In addition, the manifold refrigerant module at least includes a chiller and a condenser as the heat exchanger.

In this case, the chiller and the condenser are configured so that the inlet and the outlet are disposed adjacent to each other in the direction of gravity by an assembly port.

In addition, when the assembly port of the chiller is disposed at one side in the left-right direction, the assembly port of the condenser may be disposed at the other side.

In addition, the manifold is assembled by welding a first housing in which a plurality of flow paths are formed and which forms a floor surface, a second housing in which a plurality of flow paths are formed and which forms a top surface, and a middle plate interposed between the first housing and the second housing and blocking open portions of the flow paths formed on the first housing and the second housing to form a flow path space.

In this case, the manifold includes a protrusion formed to protrude from an edge of one of the first housing and the second housing toward the middle plate, and the protrusion comes into contact with all of the first housing, the second housing, and the middle plate and fixes a position of each plate.

In addition, the manifold has the flow path part and the valve block formed integrally.

In addition, the manifold includes one or more straight and curved fluid flow paths in the flow path part.

### BRIEF DESCRIPTION OF THE DRAWINGS

FIG. 1 is a perspective view of the entirety of a manifold refrigerant module according to one embodiment.

FIG. 2 is a plan view of the entirety of the manifold refrigerant module according to one embodiment.

FIG. 3 is a plan view of a manifold according to one embodiment.

FIG. 4 is a transmissive plan view of a chiller according to one embodiment.

FIG. 5 is a transmissive plan view of a condenser according to one embodiment.

FIG. 6 is a transmissive plan view of the entirety of the manifold refrigerant module according to one embodiment.

### DETAILED DESCRIPTION OF THE INVENTION

Hereinafter, the technical spirit of the present invention will be described in more detail with reference to the accompanying drawings. The terms or words used in the present specification and claims are not to be narrowly interpreted according to their general or dictionary meanings and should be interpreted as having meanings and concepts that are consistent with the technical idea of the present invention on the basis of the principle that an inventor can be his/her own lexicographer to appropriately define concepts of terms to describe his/her invention in the best way.

Accordingly, since the embodiments described in the present specification and the configurations illustrated in the drawings are only the best exemplary embodiment of the present invention and do not represent the technical spirit of the present invention, it should be understood that there may be various modifications which can replace them at the time of filing this application.

Hereinafter, the technical spirit of the present invention will be described in more detail with reference to the accompanying drawings. Since the accompanying drawings are merely examples illustrated to more specifically describe the technical spirit of the present invention, the technical spirit of the present invention is not limited to the form of the accompanying drawings.

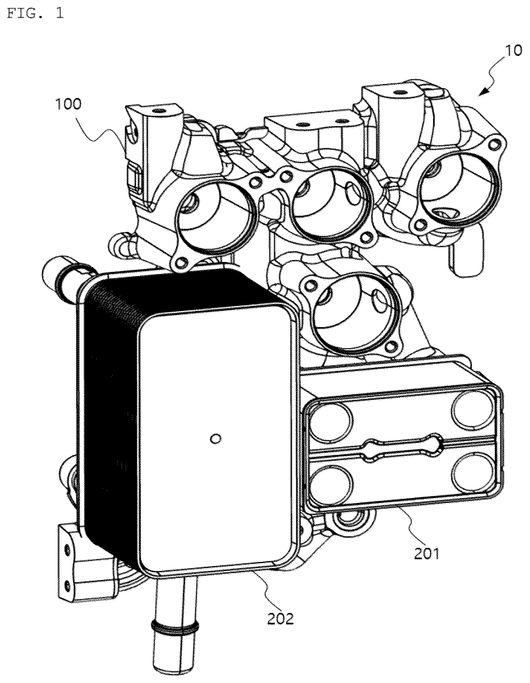

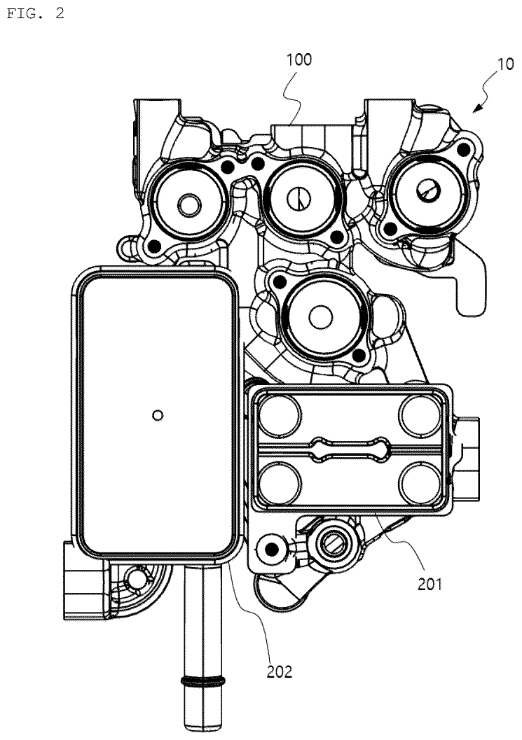

Referring to FIGS. 1 and 2, a manifold refrigerant module 10 of the present invention may include a manifold 100 which is disposed at an upper side in a direction of gravity and in which a plurality of fluid flow paths are formed, and at least one heat exchanger 200 which is coupled to a lower side of the manifold 100 and communicates with the flow paths through an inlet and an outlet so that a fluid flows and is heat-exchanged.

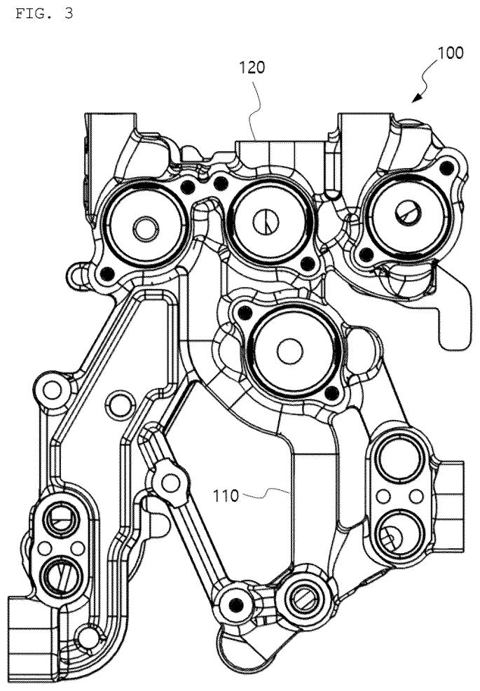

Referring to FIG. 3, the manifold 100 of the present invention includes a flow path part 110 including a plurality of fluid flow paths and a valve block 120 for installation of a valve for controlling a flow of a fluid flowing along the flow path. In this case, the fluid flowing in the manifold 100 may be refrigerant. Here, the manifold 100 may be formed so that the flow path part 110 and the valve block 120 are positioned separately. That is, the manifold 100 may be in the form in which the flow path part 110 is disposed at one side and the valve block 120 is disposed at the other side. In one embodiment of the present invention, the manifold 100 may have the valve block 120 disposed at an upper side thereof and the flow path part 110 disposed at a lower side of the valve block 120 in the direction of gravity. In this case, the manifold 100 may have the flow path part 110 and the valve block 120 formed integrally.

In addition, the manifold 100 of the present invention may have a structure that is assembled by welding a first housing in which a plurality of flow paths are formed and which forms a floor surface, a second housing in which a plurality of flow paths are formed and which forms a top surface, and a middle plate interposed between the first housing and the second housing and blocking open portions of the flow paths formed on the first housing and the second housing to form a flow path space. That is, the manifold 100 may be assembled by welding the first housing, the middle plate, and the second housing that are sequentially stacked in surface contact with each other. In this case, the manifold 100 assembled through welding in a stacking direction may have a form in which the valve block 120 is positioned at an upper end thereof and the flow path part 110 is positioned at a lower end thereof in the direction of gravity.

In this case, in one embodiment of the present invention, the manifold 100 of the present invention may further include a structure that may be assembled by welding the first housing, the middle plate, and the second housing that are stacked in a triple-layered manner, thereby preventing the middle plate from being separated from a correct position during assembly. More specifically, the manifold 100 has a protrusion formed to protrude toward the middle plate and formed on at least one of the first housing and the second housing. The protrusion may be formed at one or more edges of the first housing and the second housing and formed to protrude toward the middle plate in the stacking direction. Accordingly, an inner surface of the protrusion may come into contact with an edge of the middle plate to perform guidance to the correct position of the middle plate and position support of the middle plate. Accordingly, the manifold 100 of the present invention includes a structure capable of effectively restricting the rotation of the middle plate by the protrusion.

Accordingly, the flow path part 110 may have a form including a structure having a plurality of flow paths, and the plurality of flow paths may be formed by the flow paths formed on each housing by coupling the first and second housings formed by hot forging and facing each other. In this case, the flat middle plate formed by the press may determine a direction of the flow path while blocking the open portions. Here, the first housing, the middle plate, and the second housing may be welded using a vacuum brazing method. Accordingly, since the flow path part of the present invention is manufactured by vacuum brazing, the flow path part may freely implement straight lines and curves and include at least one straight and curved fluid flow path. In the flow path part 110, a flow passage of a fluid may be determined by welding the first housing, the middle plate, and the second housing.

The valve block 120 may include at least one valve capable of controlling transport such as a flow volume or flow direction of a fluid flowing along each of the plurality of fluid flow paths formed in the flow path part 110. Referring to FIG. 3, the valve block 120 is formed in the form of a block for installation of valves of the flow path part 110 at specific positions. The valve block 120 includes at least one valve, and when including a plurality of valves, the valve block 120 may control the fluid flowing along each flow path equally or differently. The valve block may be processed so that modes such as A/C and H/P are implemented by rotating balls of one or more refrigerant valves in accordance with a refrigerant circuit mode.

The heat exchanger 200 of the present invention is a device that is coupled to the manifold 100 so that a fluid flows therebetween and heat-exchanged by the circulation of refrigerant flowing along the flow path. The manifold refrigerant module 10 of the present invention includes at least one heat exchanger 200, and the heat exchanger 200 includes an inlet and an outlet that communicate with the manifold 100. The heat exchanger 200 may be used without limitation as long as it is a device heat-exchanged through a fluid and may include a plurality of heat exchangers 200 depending on the characteristics of the refrigerant manifold 100 module. Referring to FIGS. 1 and 2, as an example, the manifold refrigerant module 10 of the present invention may include two heat exchangers 200, and each heat exchanger 200 may include an inlet and an outlet. In this case, the heat exchanger 200 may at least include a chiller and a condenser. Here, even when the plurality of heat exchangers 200 are provided, all heat exchangers 200 are preferably disposed under the manifold 100.

The refrigerant flowing into the heat exchanger 200 from the manifold 100 through the inlet of the heat exchanger 200 is heat-exchanged while circulating and then is discharged back to the manifold 100 through the outlet of the heat exchanger 200. Here, in the heat exchanger 200, a fluid flow of the refrigerant circulating inside the heat exchanger 200 may be formed differently depending on positions of the inlet and the outlet, a pressure drop may occur depending on the flow, and in this case, the pressure drop may cause oil and refrigerant to be trapped inside the heat exchanger 200 and the manifold 100. In particular, when the inlet and the outlet are disposed at an upper end of the heat exchanger 200 in the direction of gravity within the heat exchanger 200, there is a high possibility that oil and refrigerant will be trapped when the refrigerant circulating in the heat exchanger 200 moves from the inlet to the outlet. Accordingly, the present invention provides the manifold refrigerant module 10 having a structure for preventing oil and refrigerant from being trapped in the heat exchanger 200 or the manifold 100 by restricting the positions of the inlet and the outlet.

The manifold refrigerant module 10 of the present invention is configured so that the inlet of the heat exchanger 200 is disposed above the outlet of the heat exchanger 200 in the heat exchanger 200 in the direction of gravity. The manifold refrigerant module 10 of the present invention is configured to have the manifold 100 disposed at an upper side thereof and at least one heat exchanger 200 for performing heat exchange disposed at a lower side thereof in the direction of gravity. In this case, the heat exchanger 200 includes the inlet and the outlet through which the fluid communicates with the manifold 100 and is configured so that the inlet of the heat exchanger 200 is positioned above the outlet of the heat exchanger 200 on the heat exchanger 200 so that the refrigerant may flow with the help of gravity when moving from the inlet to the outlet. In addition, in the heat exchanger 200 of the present invention, at least one of the inlet and the outlet of the heat exchanger 200 is preferably positioned at a lower end of the heat exchanger 200. It is a configuration for reducing the trapping of oil and refrigerant therein by arranging the inlet and the outlet of the heat exchanger 200 at the lowest end of the manifold refrigerant module 10 in the direction of gravity.

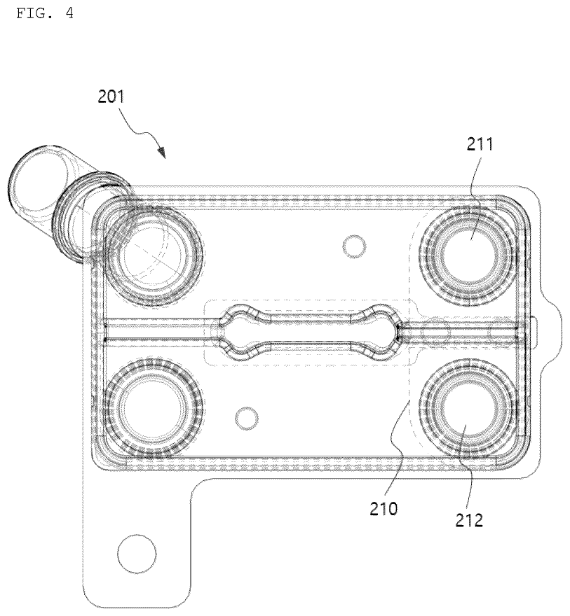

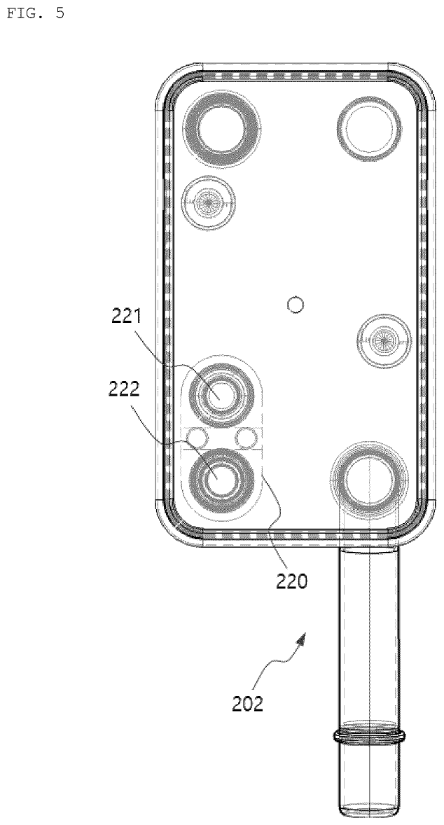

More specifically, referring to FIGS. 4 and 5, the heat exchanger 200 of the present invention includes inlets 211 and 221 through which refrigerant is introduced from the manifold 100 and outlets 212 and 222 through which the refrigerant is discharged to the manifold 100. In this case, the inlets 211 and 221 and the outlets 212 and 222 may all be disposed at a lower portion of the heat exchanger 200, but in this case, the inlets 211 and 221 are preferably disposed at higher positions than the outlets 212 and 222. Alternatively, at least one of the inlets 211 and 221 and the outlets 212 and 222 may be disposed at the lower portion of the heat exchanger 200, but in this case, the outlets 212 and 222 are preferably disposed at the lower end of the heat exchanger 200, and the inlets 211 and 221 are preferably disposed at the upper end thereof.

In this case, the heat exchanger 200 may be provided with the inlets 211 and 221 and the outlets 212 and 222 by assembly ports 210 and 220 as connection ports. Referring to FIGS. 4 and 5, the assembly ports 210 and 220 may be connected so that the inlets 211 and 221 and the outlets 212 and 222 are adjacent to each other. In particular, the assembly ports 210 and 220 may be disposed so that the inlets 211 and 221 and the outlets 212 and 222 are vertically adjacent to each other in the direction of gravity. Here, at least one of the inlets 211 and 221 and the outlets 212 and 222 may be positioned at corner sides of the heat exchanger 200. However, the assembly ports 210 and 220 are preferably disposed at a side of the manifold refrigerant module 10, which is the farthest from the valve block 120.

More specifically, referring to FIGS. 1 and 2, the manifold refrigerant module 10 may have the manifold 100 disposed at the upper side thereof and the heat exchanger 200 disposed at the lower side thereof in the direction of gravity. In addition, the assembly ports 210 and 220 of the heat exchanger 200 may be disposed at the lower end of the heat exchanger 200, which is the side farthest from the manifold 100. That is, the assembly ports 210 and 220 may be disposed at the lower end of the flow path part 110, which is the side farthest from the valve block 120 of the manifold 100. However, the inlets 211 and 221 and the outlets 212 and 222 may be vertically disposed side by side by the assembly ports 210 and 220 in the heat exchanger 200. In this case, when the inlets 211 and 221 are disposed at one corner of the heat exchanger 200, the outlets 212 and 222 may be disposed at vertically downward positions of the inlets 211 and 221, and the outlets 212 and 222 in this case may not be positioned at corners of the heat exchanger 200. In addition, when the outlets 212 and 222 are disposed at one corner of the heat exchanger 200, the inlets 211 and 221 may be disposed at vertically upward positions of the outlets 212 and 222, and the inlets 211 and 221 in this case may not be positioned at corners of the heat exchanger 200. However, when a length of the heat exchanger 200 in the direction of gravity is a length corresponding to lengths of the assembly ports 210 and 220, the inlets 211 and 221 and the outlets 212 and 222 may be disposed at upper and lower corners at one side in a left-right direction.

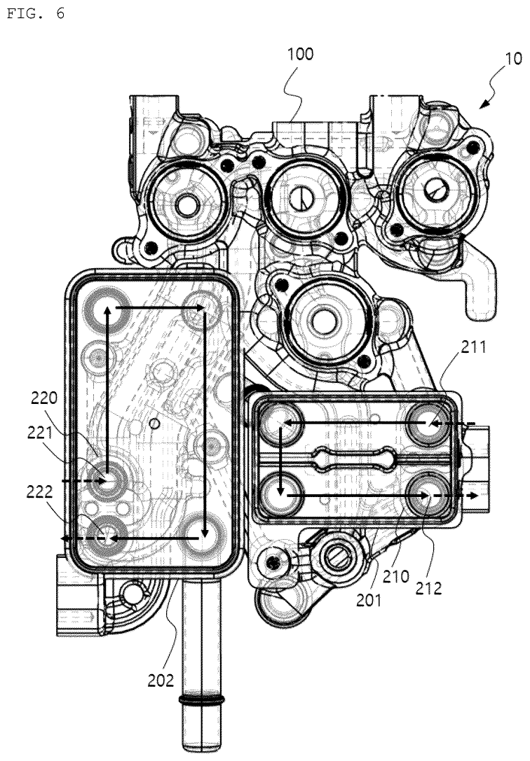

Here, the manifold refrigerant module 10 of the present invention may include the heat exchanger 200 of a chiller 201 and a condenser 202. In this case, as illustrated in FIG. 6, the manifold refrigerant module 10 may have the chiller 201 and the condenser 202 each disposed at the lower side of the manifold 100. In this case, the valve block 120 may be disposed at the upper end of the manifold 100, the flow path part 110 may be disposed at the lower end thereof, and the chiller 201 and the condenser 202 may be disposed at the flow path part 110 side. In this case, depending on a space size in the module, the chiller 201 and the condenser 202 may be disposed to overlap the flow path part 110 of the manifold 100. In addition, the chiller 201 and the condenser 202 include the assembly ports 210 and 220, respectively. In this case, the chiller 201 and the condenser 202 may be formed in different sizes. However, regardless of the size, the assembly ports 210 and 220 of the chiller 201 and the condenser 202 are preferably disposed at the lower portion, which is a position farthest from the valve block 120 of the manifold 100.

In addition, in the manifold refrigerant module, the chiller and the condenser may be disposed so that the inlets and the outlets are adjacent to each other in the direction of gravity by the assembly ports. Here, when the assembly port of the chiller is disposed at one side in the left-right direction, the assembly port of the condenser may be disposed at the other side. That is, the inlets 211 and 221 and the outlets 212 and 222 may be vertically disposed in the direction of gravity in the assembly ports 210 and 220. In this case, in the assembly ports 210 and 220, at least one of the inlets 211 and 221 and the outlets 212 and 222 is preferably disposed at one corner of the heat exchanger 200, and here, the inlets 211 and 221 are preferably disposed above the outlets 212 and 222. That is, the positions of the chiller 201 and the condenser 202 are limited so that the outlets 212 and 222 are disposed at the lowest end thereof and the inlets 211 and 221 are disposed above the outlets 212 and 222.

Accordingly, based on an example in which the refrigerant of each heat exchanger 200 circulates in the plan direction of the heat exchanger 200, in the chiller 201 and the condenser 202, since a fluid discharge flow in which the fluid introduced through the inlets 211 and 221 moves upward and circulates clockwise or counterclockwise in the plan direction of each heat exchanger 200, moves downward in the direction of gravity, and then is discharged through the outlets 212 and 222 is formed, the heat exchanger 200 improves the flow of the fluid.

More specifically, referring to FIG. 6, when the condenser 202 is coupled to the manifold refrigerant module 10 in the form having a vertical length in the direction of gravity, an assembly port may be disposed at a lower left end of the condenser 202. In this case, the outlet 222 may be disposed at the corner of the condenser 202, and the inlet 221 may be disposed above the outlet 222. Accordingly, the condenser 202 may be configured so that the refrigerant introduced through the inlet 221 may move upward, circulate clockwise along the flat surface of the condenser 202, move downward in the direction of gravity with the help of gravity before moving to the outlet 222, and may be discharged through the outlet 222 positioned at the left corner thereof.

In addition, referring to FIG. 6, when the chiller 201 is coupled to the manifold refrigerant module 10 in the form having a larger horizontal length than the condenser 202 and having a smaller size than the condenser 202, an assembly port may be disposed at a right end of the chiller 201. However, since the vertical length of the chiller 201 corresponds to the length of the assembly port, the assembly port may be disposed along an edge of the right end of the chiller 201. In this case, the outlet 212 may be disposed at a lower right edge of the chiller 201, and the inlet 211 may be disposed at an upper right edge of the chiller 201. Accordingly, the chiller 201 may be configured so that the refrigerant introduced through the inlet 211 may move to the left, circulate counterclockwise along the flat surface of the condenser 202, move downward in the direction of gravity with the help of gravity before moving to the outlet 212, and may be discharged through the outlet 212 positioned at the right corner thereof.

Accordingly, the heat exchanger 200 of the present invention can minimize the pressure drop of the refrigerant because the refrigerant may be discharged after circulating with the help of gravity, thereby reducing the possibility of oil and refrigerant that are trapped in the heat exchanger, and as a result, it is possible to provide the manifold refrigerant module with high heat exchange efficiency and improved stability.

According to the refrigerant manifold module of the present invention in accordance with the above configuration, by reflecting the characteristics of the refrigerant manifold to which the heat exchanger is assembled and the structure of the heat exchanger to restrict the position of the assembly port of the heat exchanger and the manifold, it is possible to minimize a pressure drop of refrigerant, prevent oil and refrigerant from being trapped due to the pressure drop, and furthermore, provide the heat exchanger with the maximized refrigerant flow efficiency, increase the effect of cost saving and packability of the cooling system due to miniaturization and simplification of the plurality of pipes using the manifold, freely implement the flow path along which refrigerant flows without any limitation, such as a curve and a straight line to improve the degree of freedom in terms of a structure and production design, and provide ease of assembly and installation by integrating the heat exchanger and the manifold.

Although the present invention has been described above by specific matters such as specific components and limited embodiment drawings, it is provided only to help a more general understanding of the present invention, the present invention is not limited to the above one embodiment, and those skilled in the art to which the present invention pertains can make various modifications and variations from this description.

Accordingly, the spirit of the present invention should not be limited to the described embodiments, and not only the appended claims, but also all things that are equivalent or have modifications equivalent to the claims fall within the scope of the spirit of the present invention.

DESCRIPTION OF REFERENCE NUMERALS

| | |
|---|---|
| 10: manifold refrigerant module | |
| 100: manifold | |
| 110: flow path part | 120: valve block |
| 200: heat exchanger | |
| 201: chiller | 210: assembly port |
| 211: inlet | 212: outlet |
| 202: condenser | 220: assembly port |
| 221: inlet | 222: outlet |

What is claimed is:

1. A manifold refrigerant module comprising a manifold in which a plurality of fluid flow paths are formed; and at least one heat exchanger coupled to a lower side of the manifold and configured to communicate with the flow path through an inlet and an outlet so that a fluid flows and is heat-exchanged,
wherein the inlet is disposed above the outlet in the heat exchanger.

2. The manifold refrigerant module of claim 1, wherein at least one of the inlet and the outlet of the heat exchanger is disposed at a lower end side of the heat exchanger.

3. The manifold refrigerant module of claim 2, wherein the inlet and the outlet of the heat exchanger are disposed adjacent to each other in a direction of gravity by an assembly port.

4. The manifold refrigerant module of claim 3, wherein the at least one of the inlet and the outlet is positioned at a corner side of the heat exchanger.

5. The manifold refrigerant module of claim 3, wherein the manifold includes:
a flow path part positioned at a lower side thereof and including a plurality of flow paths formed through vacuum brazing; and
a valve block positioned above the flow path part and for installation of a valve configured to control a flow of a fluid flowing along the flow path.

6. The manifold refrigerant module of claim 5, wherein the assembly port is positioned at a side farthest from the valve block.

7. The manifold refrigerant module of claim 6, wherein the heat exchanger forms a fluid flow in which a fluid introduced through the inlet circulates clockwise or counterclockwise along a flat surface of the heat exchanger and then is discharged through the outlet.

8. The manifold refrigerant module of claim 4, wherein the heat exchanger forms a fluid flow in which a fluid introduced through the inlet circulates along a flat surface of the heat exchanger, moves downward in the direction of gravity, and then is discharged through the outlet.

9. The manifold refrigerant module of claim 8, wherein the heat exchanger minimizes a pressure drop by the fluid flow moving downward in the direction of gravity, thereby preventing refrigerant from being trapped.

10. The manifold refrigerant module of claim 1, at least comprising a chiller and a condenser as the heat exchanger.

11. The manifold refrigerant module of claim 10, wherein the chiller and the condenser are configured so that the inlet and the outlet are disposed adjacent to each other in the direction of gravity by an assembly port.

12. The manifold refrigerant module of claim 11, wherein, when the assembly port of the chiller is disposed at one side in a left-right direction,
the assembly port of the condenser is disposed at the other side.

13. The manifold refrigerant module of claim 5, wherein the manifold is assembled by welding
a first housing in which a plurality of flow paths are formed and which forms a floor surface,
a second housing in which a plurality of flow paths are formed and which forms a top surface, and
a middle plate interposed between the first housing and the second housing and blocking open portions of the flow paths formed on the first housing and the second housing to form a flow path space.

14. The manifold refrigerant module of claim 13, wherein the manifold includes a protrusion formed to protrude from an edge of one of the first housing and the second housing toward the middle plate, and
the protrusion comes into contact with all of the first housing, the second housing, and the middle plate and fixes a position of each plate.

15. The manifold refrigerant module of claim 5, wherein the manifold has the flow path part and the valve block formed integrally.

16. The manifold refrigerant module of claim 5, wherein the manifold includes one or more straight and curved fluid flow paths in the flow path part.
